(19) United States
(12) Patent Application Publication
(10) Pub. No.: US 2026/0136249 A1
(43) Pub. Date: May 14, 2026

(54) SWITCHING USER BEARER CONTEXT TO AN ACTIVE G-NODEB (gNB)-CENTRALIZED UNIT CONTROL PLANE (CUUP) INSTANCE

(71) Applicant: RAKUTEN SYMPHONY, INC., Tokyo (JP)

(72) Inventors: Santhiyaku Jeevakumar ANTONYRAJ, Karnataka (IN); Prabhakara Ramesh REDDY, Karnataka (IN)

(73) Assignee: RAKUTEN SYMPHONY, INC., Tokyo (JP)

(21) Appl. No.: 19/078,512

(22) Filed: Mar. 13, 2025

(30) Foreign Application Priority Data
Nov. 12, 2024 (IN) 202411087118

(51) Int. Cl. H04W 36/06; H04W 36/00; H04W 72/53

(52) U.S. Cl. CPC H04W 36/06; H04W 36/0069; H04W 72/53

(57) ABSTRACT

A method for switching user bearer context to an active gNB-CUUP instance includes receiving an indication indicating a failure of a current CUUP associated with the CUCP, determining a list of plurality of users associated with the current CUUP and an associated priority order, selecting at least one active CUUP associated with the CUCP, determining a load status of the active CUUP based on associated user instances, performing one of: performing an intra-cell handover process to switch a user bearer context from the current CUUP to the active CUUP based on the corresponding priority order when the load status is below a predefined threshold, or pre-empting one or more user instances associated with the active CUUP when the load status is above the predefined threshold, and performing the intra-cell handover process to switch a first set of users to the active CUUP based on the corresponding priority orders.

### CROSS REFERENCE TO RELATED APPLICATIONS

This application claims priority based on India Patent Application No. 202411087118 filed November 12, 2024, the entire disclosure of which is incorporated by reference herein.

### FIELD

The present disclosure relates to switching user bearer context to an active gNB- Centralized Unit User Plane (CUUP) instance when a connected gNB-CUUP instance is down.

### BACKGROUND

The information disclosed in this background section is only for the enhancement of understanding of the general background of the disclosure and should not be taken as an acknowledgment or any form of suggestion that this information forms the prior art already known to a person skilled in the art.

The 3rd Generation Partnership Project (3GPP) has defined a disaggregated RAN architecture decomposing a gNodeB (gNB) into multiple logical entities. Further, for the gNB in 5^{th} Generation (5G) New Radio (NR) systems, such disaggregated entities include at least one Distributed Unit (DU) and a Centralized Unit (CU). The CU may be further split into a CU Control Plane (CP) part, also referred to as CU-C or CUCP, and a CU User Plane (UP) part, also referred to as CU-U or CUUP. The CUUP can be connected to the CUCP, and a plurality of user equipment (UEs) may be linked to a CUUP. While data related to these UEs is stored in the CUUP, their user context is maintained in the CUCP. However, if the CUUP fails, the data stored in the CUUP may be lost, leading to a call drop and consequently diminishing the user experience.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method is disclosed. The method includes receiving, by a Centralized Unit Control Plane (CUCP), an indication indicating a failure of a current CU-User Plane (CUUP) associated with the CUCP. The method further comprises determining, by the CUCP, a list of plurality of users associated with the current CUUP and an associated priority order corresponding to each of the users. The method also comprises selecting, by the CUCP, at least one active CUUP among a plurality of active CUUPs associated with the CUCP. The method further comprises determining, by the CUCP, a load status of the at least one active CUUP based on associated user instances. The method further includes performing, by the CUCP, one of: performing an intra-cell handover process to switch a user bearer context associated with each of the plurality of users from the current CUUP to the at least one active CUUP based on the corresponding priority order, when the load status is below a predefined threshold, or pre-empting one or more user instances corresponding to one or more non-priority users associated with the at least one active CUUP when the load status is above the predefined threshold, and performing the intra-cell handover process to switch a first set of users among the plurality of users associated with the current CUUP to the at least one active CUUP based on the corresponding priority orders.

According to one embodiment of the present disclosure, an apparatus is disclosed. The apparatus is configured to receive an indication indicating a failure of a current Centralized Unit-User Plane (CUUP) associated with the CUCP. The apparatus is further configured to determine a list of a plurality of users associated with the current CUUP and an associated priority order corresponding to each of the users. The apparatus is further configured to select at least one active CUUP among a plurality of active CUUPs associated with the CUCP. The apparatus is further configured to determine a load status of the at least one active CUUP based on associated user instances. The apparatus is configured to perform one of: perform an intra-cell handover process to switch a user bearer context associated with each of the plurality of users from the current CUUP to the at least one active CUUP based on the corresponding priority order, when the load status is below a predefined threshold, or pre-empt one or more user instances corresponding to one or more non-priority users associated with the at least one active CUUP when the load status is above the predefined threshold, and perform the intra-cell handover process to switch a first set of users among the plurality of users associated with the current CUUP to the at least one active CUUP based on the corresponding priority orders.

According to one embodiment of the present disclosure, a non-transitory computer-readable medium is disclosed. The non-transitory computer-readable medium storing instructions, the instructions comprising: one or more instructions that, when executed by a Centralized Unit Control Plane (CUCP), the CUCP comprising one or more processors, cause the one or more processors to receive an indication indicating a failure of a current CU-User Plane (CUUP) associated with the CUCP. The one or more instructions further cause the one or more processors to determine a list of plurality of users associated with the current CUUP and an associated priority order corresponding to each of the users. The one or more instructions further cause the one or more processors to select at least one active CUUP among a plurality of active CUUPs associated with the CUCP. The one or more instructions further cause the one or more processors to determine a load status of the at least one active CUUP based on associated user instances. The one or more instructions further cause the one or more processor to perform one of: perform an intra-cell handover process to switch a user bearer context associated with each of the plurality of users from the current CUUP to the at least one active CUUP based on the corresponding priority order, when the load status is below a predefined threshold, or pre-empt one or more user instances corresponding to one or more non-priority users associated with the at least one active CUUP, when the load status is above the predefined threshold, and perform the intra-cell handover process to switch a first set of users among the plurality of users associated with the current CUUP to the at least one active CUUP based on the corresponding priority orders.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a signal flow diagram illustrating a call drop in a Radio Access Network (RAN) architecture, according to a related art;

FIG. 2 illustrates a block diagram of a 5G communication network, according to an embodiment of the present disclosure;

FIGS. 3A-6 illustrate signal flow diagrams depicting switching of a user bearer context associated with a current CUUP to an active CUUP, according to an embodiment of the present disclosure;

FIG. 7 illustrates a flow diagram depicting a method for switching of the user bearer context to the active CUUP, according to an embodiment of the present disclosure; and

FIG. 8 is a diagram of example components of a wireless communication device, according to an embodiment of the present disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from the practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, and one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from the practice of the implementations.

It should be noted that the terms “gNB-CUCP” and “gNB-CUUP” have been interchangeably used with the terms “CUCP” and “CUUP”, respectively.

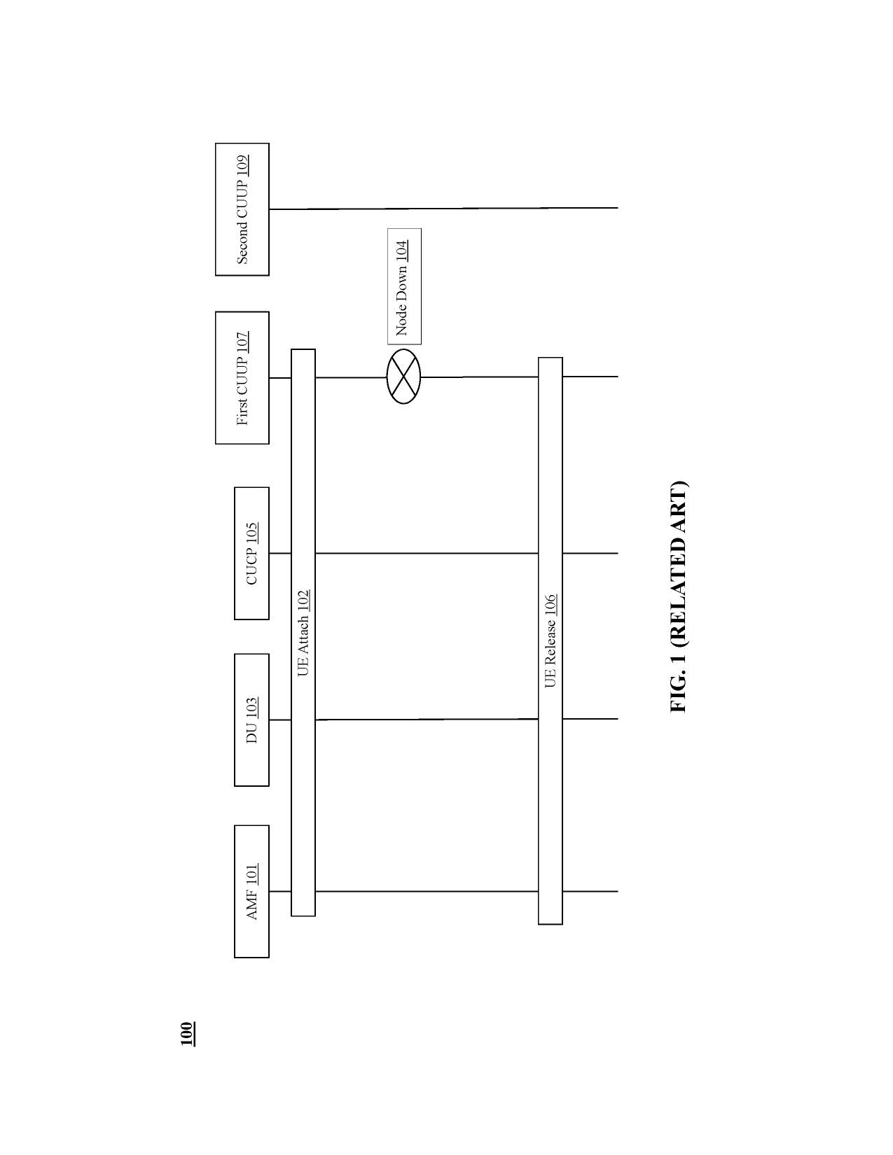

FIG. 1 illustrates a signal flow diagram illustrating a call drop in a Radio Access Network (RAN) architecture, according to a related art. As shown in FIG. 1, at operation 102, a User Equipment (UE) connects to a first Centralized Unit User Plane (CUUP) 107 through a UE attach procedure. At operation 104, the first CUUP 107 is down. At operation 106, the UE is released from the first CUUP 107. Data related to the UE is stored in the first CUUP 107, and the corresponding user context is maintained in a CU-Control Plane (CUCP) 105. However, when the UE is released due to the first CUUP 107 going down, the stored data at the first CUUP 107, including the UE context at the CUCP 105, is also deleted. Consequently, the CUCP 105 cannot connect the UE to another CUUP (for example, a second CUUP 109) since the UE context has been erased. Additionally, enhancing resiliency in the data path is not a feasible solution because the Packet Data Convergence Protocol (PDCP) Sequence Number (SN) needs to be updated to a database linked to the CUUP 107 for every packet, which significantly increases Central Processing Unit (CPU) overhead at the CUUP 107. Therefore, when the first CUUP 107 fails, deletion of the associated UE context or UE bearer context is unavoidable, leading to user call drop, and a decline in user experience.

The Third Generation Partnership Project (3GPP) has not proposed a solution to address the current issue discussed above. Conventional techniques attempt to solve the above discussed problem by releasing the user or bearer without considering emergency or high-priority users. Accordingly, the conventional technique causes service interruptions, resulting in a poor experience for the users needing priority or emergency access..

The present disclosure solves one or more of the above-mentioned problems by determining a load status of the second CUUP 109 to enable effective shifting of instances associated with the first CUUP 107, performing an intra-cell handover process when the second CUUP 109 is underloaded and preempting UEs in an overloaded CUUP state of the second CUUP 109.

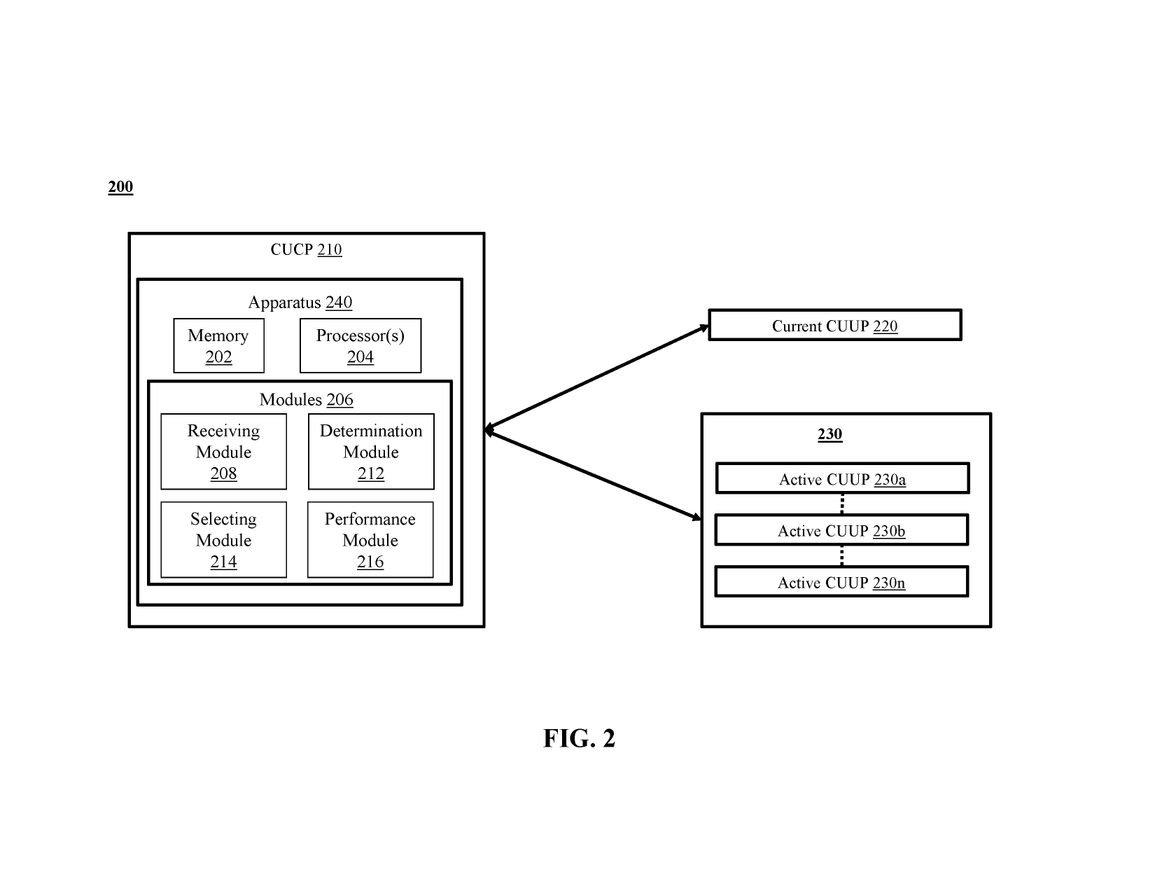

Referring now to the drawings, and more particularly to FIGS. 2 to 8, where similar reference characters denote corresponding features consistently throughout the figures, there are shown preferred embodiments.

FIG. 2 illustrates a block diagram of a 5G communication network 200, according to an embodiment of the present disclosure. As shown, the 5G communication network 200 may include a CUCP 210 which may be connected to a plurality of CUUPs, i.e., a current CUUP 220 and a plurality of active CUUPs 230a. A plurality of UEs (not shown in the figure) may be associated with the current CUUP 220. However, in one or more embodiments of the present disclosure, the plurality of UEs may be switched to one or more of the plurality of active CUUPs 230a in case of a failure of the current CUUP 220.. The CUCP 210 may include an apparatus 240 configured to perform one or more operations of the CUCP 210. In one embodiment, the apparatus 240 may be implemented within a network entity, for example a base station.

The apparatus 240 may be configured to receive an indication indicating a failure of the current CUUP 220 associated with the CUCP 210. In an embodiment, the apparatus 240 may receive the indication from a system manager associated with the CUCP 210. The system manager may reside in the CUCP 210 and monitor all the transport connections. In an embodiment, the current CUUP 220 may fail if the current CUUP 220 is down or if there is a connection failure with an associated gNB. The apparatus 240 may be further configured to determine a list of a plurality of users associated with the current CUUP 220 and an associated priority order corresponding to each of the users. In a non-limited embodiment, the apparatus 240 may determine the priority order based on priorities defined by a network operator or the user. The apparatus 240 may further be configured to select at least one of the plurality of active CUUPs 230, such as a CUUP 230a. The apparatus 240 may further be configured to determine a load status of the at least one active CUUP 230a based on associated user instances. The associated user instances may corresponds to one or more UEs connected to the at least one active CUUP 230a. For example, the apparatus 240 may determine that the at least one active CUUP 230a is underloaded if the associated user instances are below a predefined threshold. The predefined threshold may be configured by the CUCP 210. Similarly, the apparatus 240 may determine that the at least one active CUUP 230a is overloaded if the associated user instances are above the predefined threshold. For example, the predefined threshold may be defined based on a total bandwidth available to the at least one active CUCP 230a and a total number of associated user instances. In another embodiment, the predefined threshold may be defined based on the at least one active CUUP 230a E1AP STATUS Indication overload status to the CUCP 210 Further, if the apparatus 240 determines that the at least one active CUUP 230a is underloaded, then the apparatus 240 may be configured to perform an intra-cell handover process. The intra-cell handover process may be performed to switch a user bearer context associated with each of the plurality of users from the current CUUP 220 to the at least one active CUUP 230a. The apparatus 240 may switch the user bearer context based on the corresponding priority order. For example, the user bearer context having a higher priority, such as the user bearer context associated with an emergency user, may be switched prior to the user bearer context associated with other users. Accordingly, in a non-limited embodiment, the apparatus 240 may switch the user bearer context in a descending order of the associated priority order.

However, if the apparatus 240 determines that the at least one active CUUP 230a is overloaded, then the apparatus 240 may pre-empt one or more user instances corresponding to one or more non-priority users associated with the at least one active CUUP 230a. For example, as the at least one active CUUP 230a is overloaded, the at least one CUUP 230a cannot accommodate the users associated with the current CUUP 220. Hence, the non-priority users associated with the at least one active CUUP 230a may be pre-empted to accommodate the users associated with the current CUUP 220. The non-priority users may be defined by the network operator. For example, the users who fall under the category of non-emergency users, low-priority users, inactive users, N-Carrier aggregation users, dual connectivity users, cell edge users, etc., may be considered as the non-priority users. Further, in a non-limited embodiment, the apparatus 240 may pre-empt the one or more user bearer contexts associated with the one or more non-priority users, when the one or more bearer contexts are associated with at least two active CUUPs, such as the CUUPs 230a, a CUUP 230b. In another non-limited embodiment, the apparatus 240 may pre-empt the one or more user instances when a plurality of bearer contexts associated with each of the one or more user instances are associated with the at least one active CUUP, i.e. CUUP 230a. Accordingly, after pre-empting the non-priority users, the apparatus 240 may perform the intra-cell handover process to switch a first set of users among the plurality of users associated with the current CUUP 220 to the at least one active CUUP 230a. The apparatus 240 may switch the first set of users based on the corresponding priority orders. For example, the apparatus 240 may switch the user bearer context in a descending order of the corresponding priority order. In a non-limited embodiment, the first set of users may include, but are not limited to one or more of emergency users, high priority users, Radio Access Technology (RAT) Frequency Selection Priority Identifier (RFSPID)-based users, and Voice Over New Radio (VoNR) users.

In a further non-limited embodiment, the apparatus 240 may be configured to release a second set of users among the plurality of users associated with the current CUUP 220, after performing the intra-cell handover. In a non-limited embodiment, the second set of users may include, but are not limited to one or more of inactive users, N-Carrier aggregation users, dual connectivity users, and cell edge users.

The apparatus 240 may include one or more processors 204 (hereinafter referred to as the processor 204), a memory 202, and one or more modules 206. In one embodiment, the processor 204 may include at least one data processor for executing processes in Virtual Storage Area Network. The processor 204 may include specialized processing units such as integrated system (bus) controllers, memory management control units, floating point units, graphics processing units, digital signal processing units, etc. In one embodiment, the processor 204 may include a Central Processing Unit (CPU), a Graphics Processing Unit (GPU), or both. The processor 218 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 204 may execute a software program, such as code generated manually (i.e., programmed) to perform the desired operation. The processor 204 may implement various techniques such as, but not limited to, image processing, data extraction, Artificial Intelligence (AI), Machine Learning (ML), Deep Learning (DL), and so forth to achieve the desired objective.

In one embodiment, the processor 204 may be configured to perform the functions of the apparatus 240.

The memory 202 may be communicatively coupled to the processor 204. The memory 202 may be configured to store data and instructions executable by the processor 204. In one embodiment, the memory 202 may communicate via a bus within the apparatus 240. The memory 202 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 202 may include a cache or random-access memory for the processor 204. In alternative examples, the memory 202 is separate from the processor 204, such as a cache memory of a processor, the system memory, or other memory. The memory 202 may be an external storage device or database for storing data. The memory 202 may be operable to store instructions executable by the processor 204. The functions, acts, or tasks illustrated in the figures or described may be performed by the programmed processor 204 for executing the instructions stored in the memory 202. The functions, acts, or tasks are independent of the particular type of instructions set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 202 may further include a database to store the data. Further, the memory 202 may include an operating system for performing one or more tasks of the apparatus 240, as performed by a generic operating system in the communications domain.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions. The modules 206 may be configured to one or more operations of the apparatus 240 and/or the processor 204.

Further, the modules 206 can be implemented in hardware, instructions executed by a processing unit, or by a combination thereof. The processing unit can comprise a computer, the processor 204, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the present disclosure, the modules 206 may be machine-readable instructions (software) which, when executed by a processor/processing unit, perform any of the described functionalities. Furthermore, the data serves, amongst other things, as a repository for storing data processed, received, and generated by one or more of the modules. The modules 206 may include a receiving module 208, a determination module 212, a selecting module 214, and a performance module 216.

The receiving module 208 may be configured to receive the indication indicating the failure of the current CUUP 220. In a non-limited embodiment, the receiving module 208 may receive the failure indication from the system manager. The system manager may determine the failure of the current CUUP 220. The system manager may detect the failure of the current CUUP 220 if the CUUP 220 is down or if there is a connection failure with the associated gNB. In an embodiment, the system manager may frequently monitor the transport connections and detects the failure of the current CUUP 220 using known techniques, such as Stream Control Transmission Protocol (SCTP) Heartbeat mechanism.

The determination module 212 may determine the list of plurality of users associated with the current CUUP 220. The determination module 212 may also determine the associated priority order corresponding to each of the users. In a non-limited embodiment, the determination module 212 may determine the associated priority order based on the type of the user. For example, an emergency user may be assigned a first priority. Further, a VoNR user may be assigned a second priority, and so on. Accordingly, the determination module 212 may determine the associated priority order corresponding to each of the users.

The selecting module 214 may then select the at least one active CUUP 230a among the plurality of active CUUPs 230. In a non-limited embodiment, the selecting module 214 may select the at least one active CUUP 230a in a round robin manner. In an embodiment, the selecting module 214 may select the at least one active CUUP 230a based on the CUUP loaded status. In another embodiment, if more than one active CUUPs are available, then the selecting module 214 may select the at least one active CUUP 230a based on a round robin manner.

The determination module 212 may further determine the load status of the at least one active CUUP 230a based on the associated user instances. For example, the apparatus 240 may determine that the at least one active CUUP 230a is underloaded if the associated user instances are below the predefined threshold. The predefined threshold may be configured by the CUCP 210. Similarly, the apparatus 240 may determine that the at least one active CUUP 230a is overloaded if the associated user instances are above the predefined threshold.

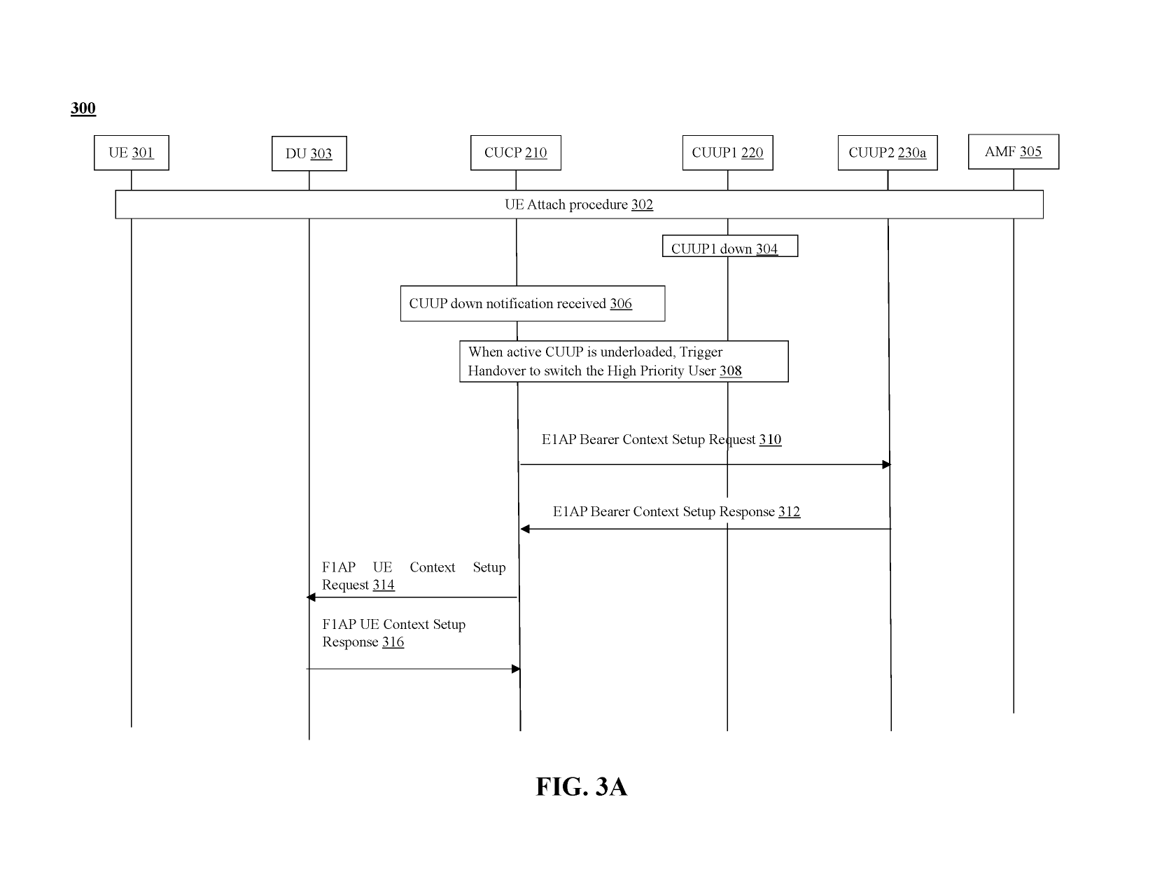

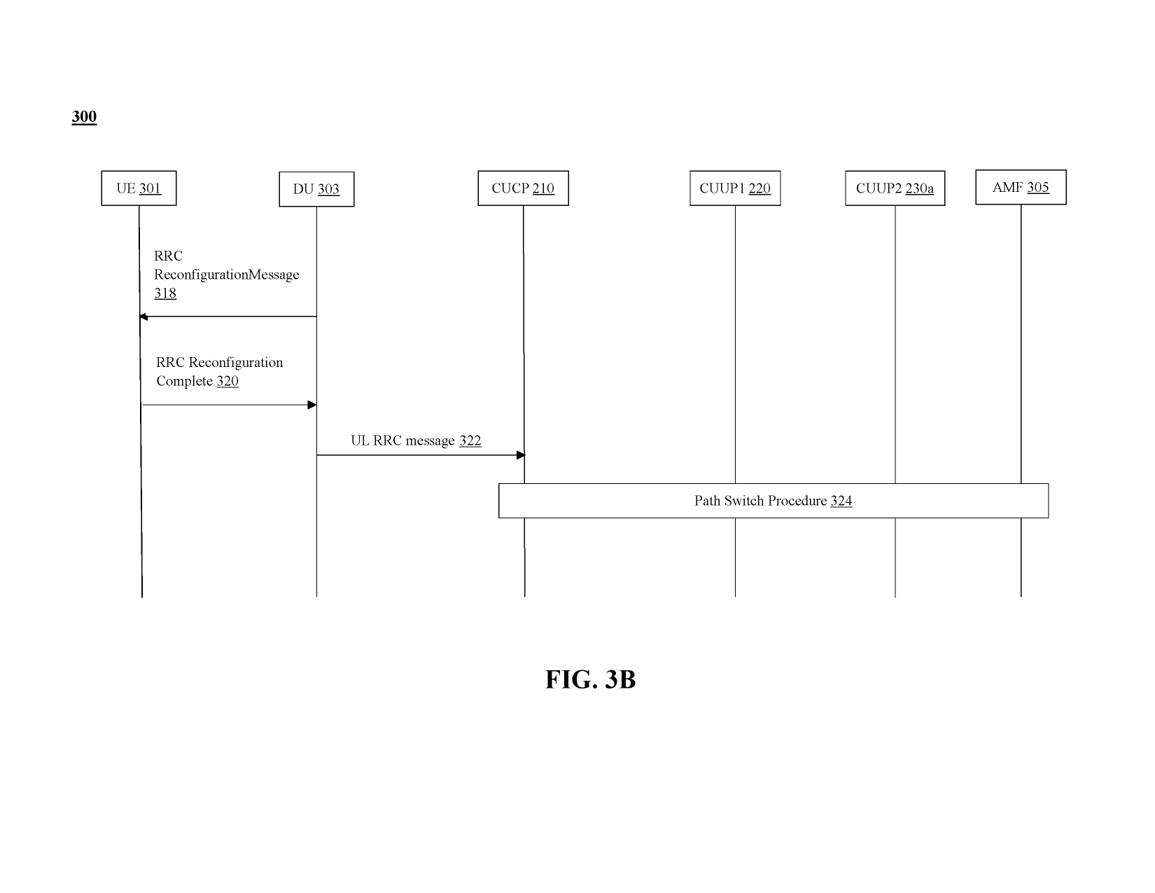

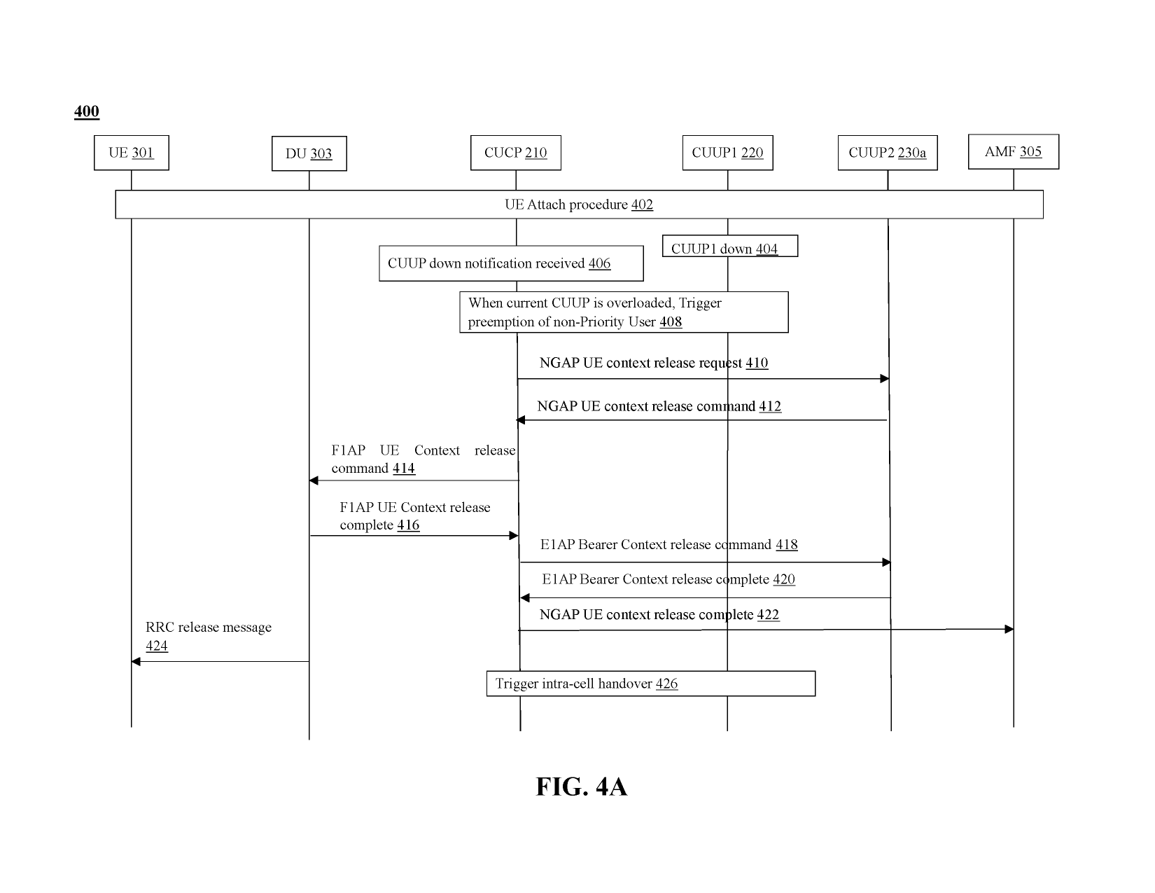

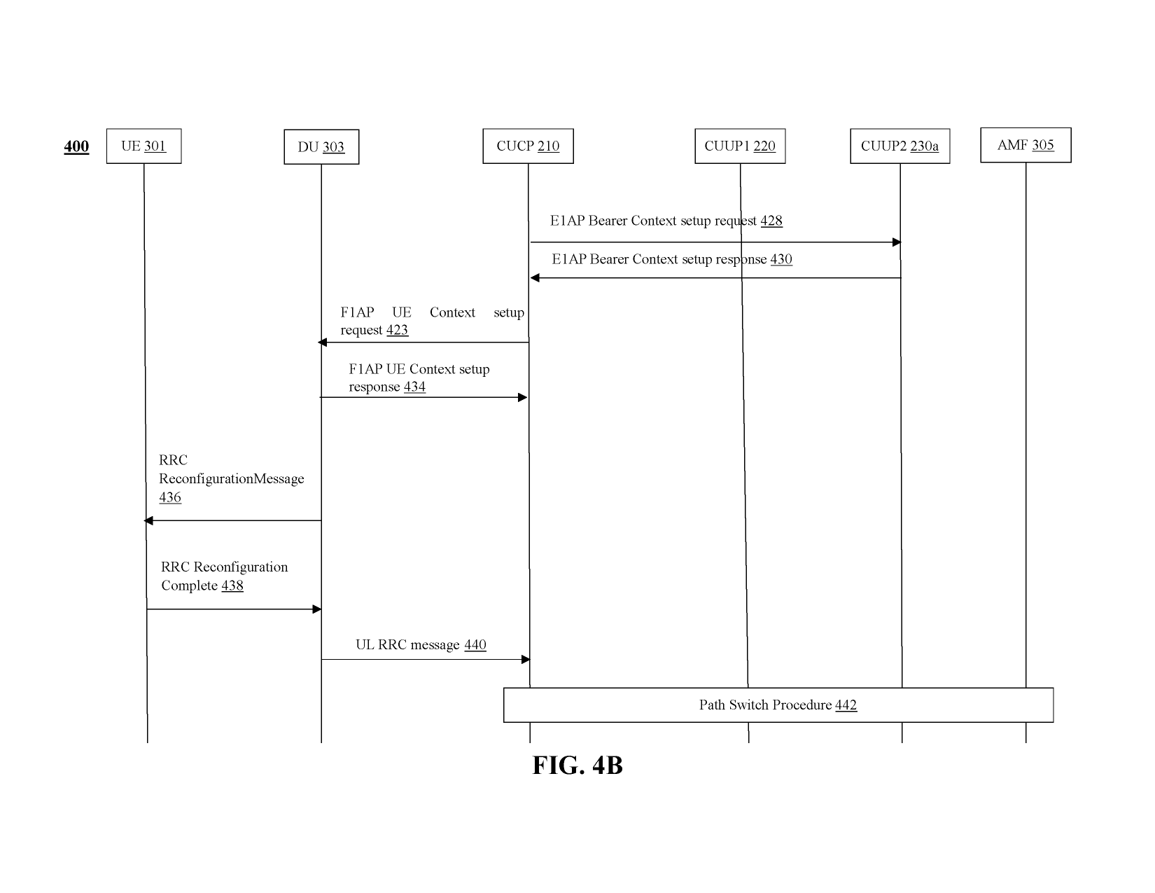

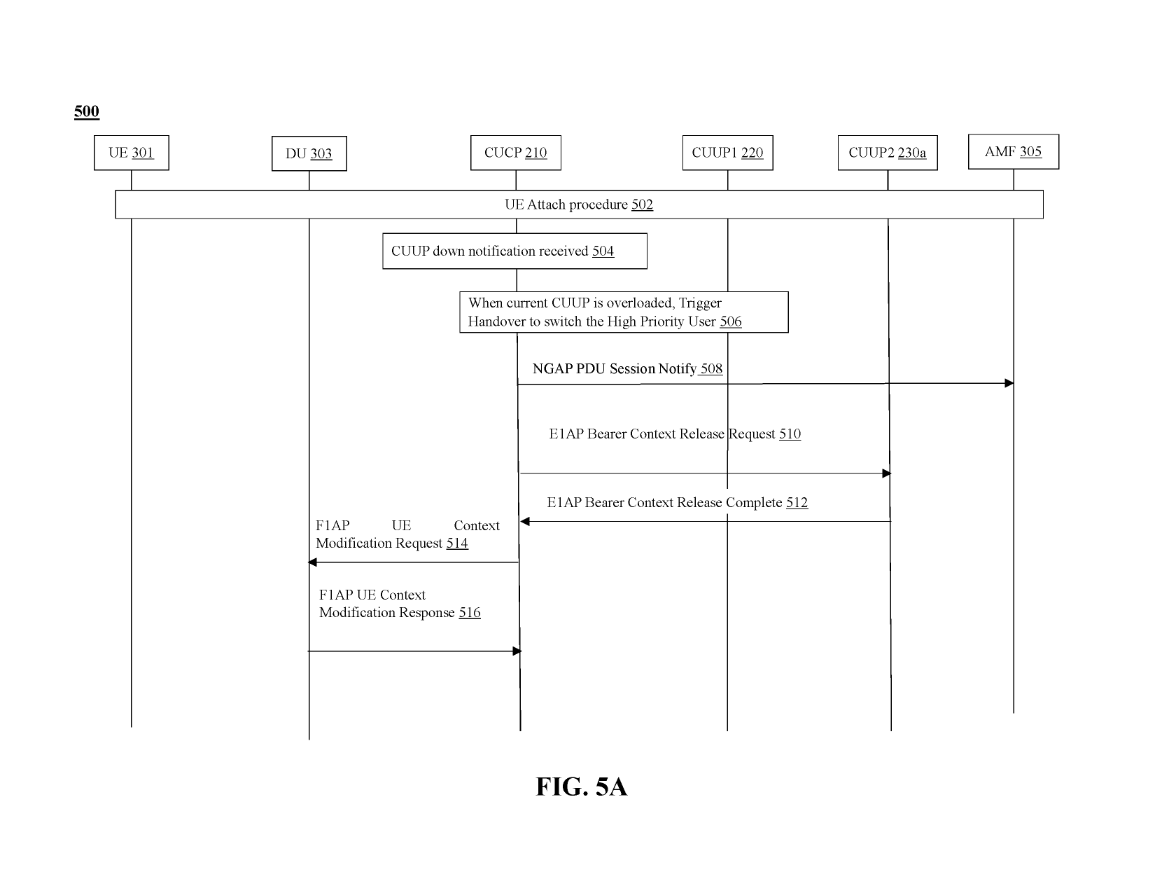

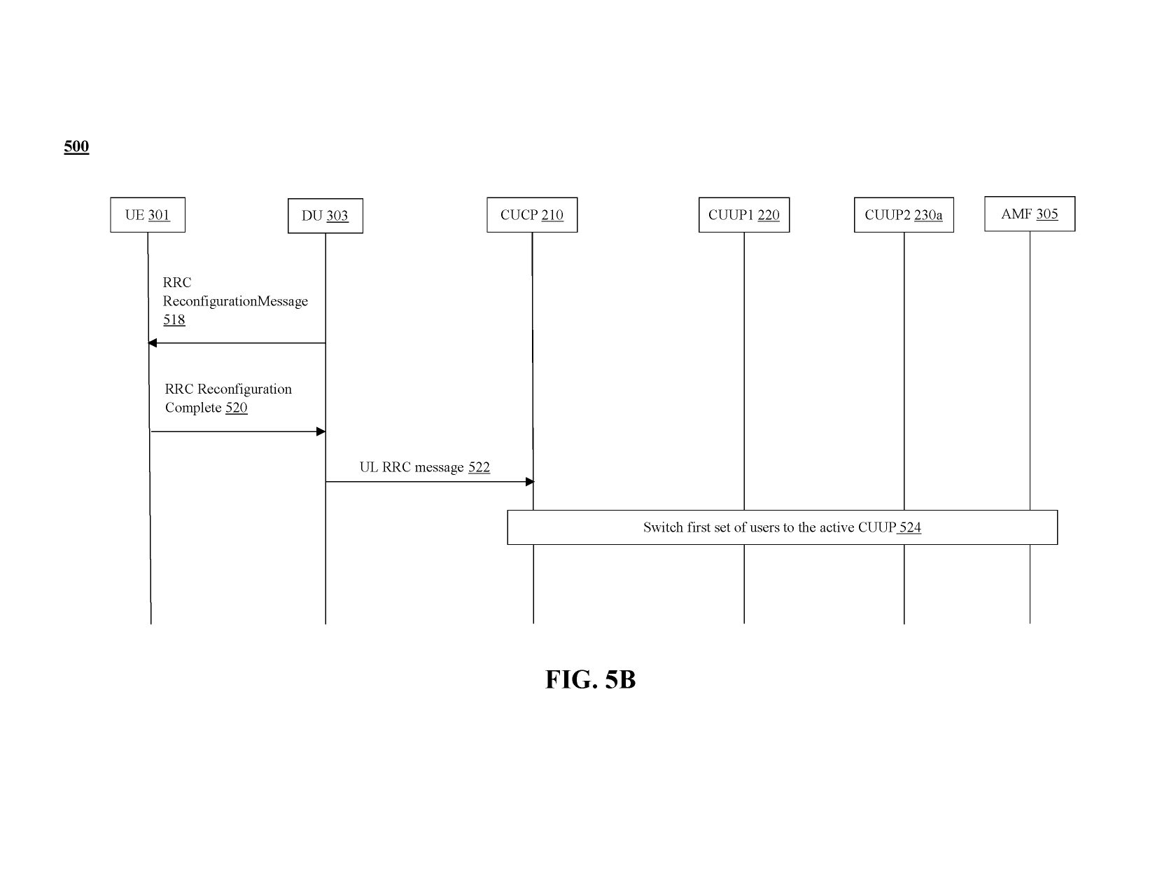

If the determination module 212 determines that the at least one active CUUP 230a is underloaded, then the performance module 216 may be configured to perform the intra-cell handover process with the at least one active CUUP 230a. The user bearer context associated with each of the plurality of users from the current CUUP 220 is switched to the at least one active CUUP 230a in the intra-cell handover process. The intra-cell handover process is further explained in reference to FIGS. 3A-3B. However, if the determination module 212 determines that the plurality of active CUUPs 230 are overloaded, then the performance module 216 may pre-empt the one or more user instances corresponding to one or more non-priority users associated with the at least one active CUUP 230a. The pre-emption of the one or more user instances is further explained in reference to FIGS. 4A-5B.

FIGS. 3A-3B illustrate a signal flow diagram 300 depicting switching of user bearer context associated with the current CUUP 220 to the at least one active CUUP 230a, when the active CUUP 230a is underloaded, according to an embodiment of the present disclosure. As shown, at operation 302, a UE 301 is connected to the current CUUP (i.e., CUUP1) 220. At operation 304, the current CUUP 220 is down. At operation 306, the CUCP 210 receives the indication of failure of the current CUUP 220. At operation 308, the CUCP 210 determines that the at least one active CUUP 230a is underloaded. Accordingly, the intra-cell handover process is performed to switch the plurality of users associated with the current CUUP 220. For example, the user bearer context associated with each of the plurality of users is switched to the at least one active CUUP 230a to switch the plurality of users. In a non-limited embodiment, the user bearer context may be switched based on the corresponding priority order, as explained in reference to FIG. 2. In order to switch the user bearer context, at operation 310, the CUCP 210 transmits an E1 Application protocol (E1AP) Bearer Context Setup Request containing an information element (IE) to the at least one active CUUP 230a. The IE may include, but is not limited to, a Packet Data Unit (PDU) resource to setup list and Uplink tunnel endpoint information of a User Plane Function (UPF). In response, at operation 312, the CUCP 210 receives an E1AP Bearer Context Setup Response. Then, at operation 314, the CUCP 210 transmits an F1 Application protocol (F1AP) UE Context Setup Request to a distribution unit (DU) 303 associated with the CUCP 210. The F1AP UE Context Setup Request may include, but is not limited to, an uplink (UL) tunnel information associated with the at least one active CUUP 230a, a Data Radio Bearer (DRB) to be released list, a DRB to add list with Radio Resource Control (RRC) container, and RRC reconfiguration to the UE 301. Thereafter, at operation 316, the CUCP 210 receives an F1AP UE Context Setup response from the DU 303. The F1AP UE Context Setup response may include, but is not limited to, a Downlink (DL) tunnel information associated with the at least one active CUUP 230a. At operation 318, the DU 303 transmits an RRC ReconfigurationMessage to the UE 301. In response, the UE 301 transmits an RRC Reconfiguration complete message to the DU 303, at operation 320. Then, at operation 322, the CUCP 210 receives an UL RRC message including the RRC Reconfiguration complete message from the DU 303. Thereafter, at operation 324, a path switch procedure is performed between the CUCP 210 and an Access and Mobility Management Function (AMF) 305 associated with the at least one active CUUP 230a. The path switch procedure is used to update the at least one active CUUP 230a downlink tunnel endpoint information to the core network to switch the data between the UPF and at least one active CUUP 230a. In particular, the CUCP 210 may transmit a path switch request with DL Tunnel information to the AMF 305. Further, in response, the CUCP 210 may receive a path request acknowledgment from the AMF 305 to switch the data associated with the UE context to the at least one active CUUP 230a.

FIGS. 4A-4B illustrates a signal flow diagram 400 depicting switching of the user bearer context associated with the current CUUP 220 to the at least one active CUUP 230a, when the at least one active CUUP 230a is overloaded, according to an embodiment of the present disclosure. In a non-limited embodiment, the performance module 216 may pre-empt the one or more user instances when a plurality of bearer contexts associated with each of the one or more user instances are associated with the at least one active CUUP, i.e. CUUP 230a. As shown, at operation 402, the UE 301 is connected to the current CUUP (i.e., CUUP1) 220. At operation 404, the current CUUP 220 is down. At operation 406, the CUCP 210 receives the indication of failure of the current CUUP 220. At operation 408, the CUCP 210 determines that the plurality of active CUUPs 230 are overloaded. Accordingly, in a non-limited embodiment, the one or more user instances are pre-empted when a plurality of bearer contexts associated with each of the one or more user instances are associated with the at least one active CUUP 230a. In order to pre-empt the one or more user instances, at operation 410, the CUCP 210 transmits a Next Generation Application Protocol (NGAP) UE context release request to the AMF 305. In response, at operation 412, the CUCP 210 receives an NGAP UE release command from the AMF 305. At operation 414, the CUCP 210 transmits an F1AP UE Context Release Request to the DU 303. In a non-limited embodiment, the UE Context Release Request may include, but is not limited to, a RRC release to UE. In response, at operation 416, the CUCP 210 receives an F1AP UE Context Release Complete from the DU 303. At operation 418, the CUCP 210 transmits an E1AP Bearer Context release command to the at least one active CUUP 230a. In response, at operation 420, the CUCP 210 receives an E1AP Bearer Context release complete from the at least one active CUUP 230a. At operation 422, the CUCP 210 transmits an NGAP UE context release complete is transmitted to the AMF 305. At operation 424, the DU 303 transmits an RRC Release message to the UE 301. Accordingly, the pre-emption process is completed. Further, after performing the pre-emption process, the performance module 216 may perform the intra-cell handover process to switch the first set of users based on the corresponding priority orders to the at least one active CUUP 230a, as discussed in reference to FIG. 2. In order to switch the first set of users, at operation 426, the CUCP 210 triggers the intra-cell handover process. It should be noted that the intra-cell process is the same as described in reference to FIGS. 3A-3B. Accordingly, operations 428 to 442 are similar to operations 310-324 of FIGS. 3A-3B. Hence, the explanation of operations 428-442 is not provided again for the sake of brevity of the present disclosure.

In another embodiment, the performance module 216 may pre-empt the one or more user bearer contexts associated with the one or more non-priority users, when the one or more bearer contexts are associated with at least two active CUUPs, such as the CUUPs 230a, 230b. The pre-emption process is further explained in reference to FIGS. 5A-5B.

FIGS. 5A-5B illustrates a signal flow diagram 500 depicting switching of the user bearer context associated with the current CUUP 220 to the active CUUP 230a, when the active CUUP 230a is overloaded, according to an embodiment of the present disclosure. As shown, at operation 502, the UE 301 is connected to the current CUUP (i.e., CUUP1) 220. At operation 504, the CUCP 210 receives the indication of failure of the current CUUP 220. At operation 506, it is determined that the at least one active CUUP 230a is overloaded. Accordingly, in a non-limited embodiment, the one or more user bearer contexts associated with the one or more non-priority users are pre-empted, when the one or more bearer contexts are associated with at least two active CUUPs, such as the CUUP 230a and the CUUP 230b.. In order to pre-empt the one or more user bearer contexts, at operation 508, the CUCP 210 transmits an NGAP PDU Session Notify message is transmitted to the AMF 305. The NGAP PDU Session Notify message may be transmitted by including the PDU Session Resource Notify Transfer IE or PDU Session Resource Notify Released Transfer IE. At operation 510, the CUCP 210 transmits an E1AP Bearer Context Release Request to the at least one active CUUP 230a. In a non-limited embodiment, the request may include, but is not limited to, a release cause and an identification of the user bearer context to be pre-empted. In response, at operation 512, the CUCP 210 receives an E1AP Bearer Context release complete from the at least one active CUUP 230a. At operation 514, the CUCP 210 transmits an F1AP UE Context Modification Request to the DU 303. In a non-limited embodiment, the UE Context Modification Request may include, but is not limited to, the DRB to be released list with RRC container and RRC Reconfiguration list to the UE. In response, at operation 516, the CUCP 210 receives an F1AP UE Context Modification Response from the DU 303. At operation 518, the DU 303 transmits the RRC Reconfigurationmessage to the UE 301. At operation 520, the DU 303 receives the RRC Reconfiguration complete message from the UE 301. Then, at operation 522, the CUCP 210 receives the UL RRC message from the DU 303. Accordingly, the pre-emption process is completed. Further, after performing the pre-emption process, at operation 524, the performance module 216 may perform the intra-cell handover process to switch the first set of users based on the corresponding priority orders to the at least one active CUUP 230a, as discussed in reference to FIG. 2. It should be noted that the intra-cell process is the same as described in reference to FIGS. 3A-3B. Hence, the explanation of the same is not provided again for the sake of brevity of the present disclosure.

In a further non-limited embodiment, the performance module 216 may release the second set of users after performing the intra-cell handover process.

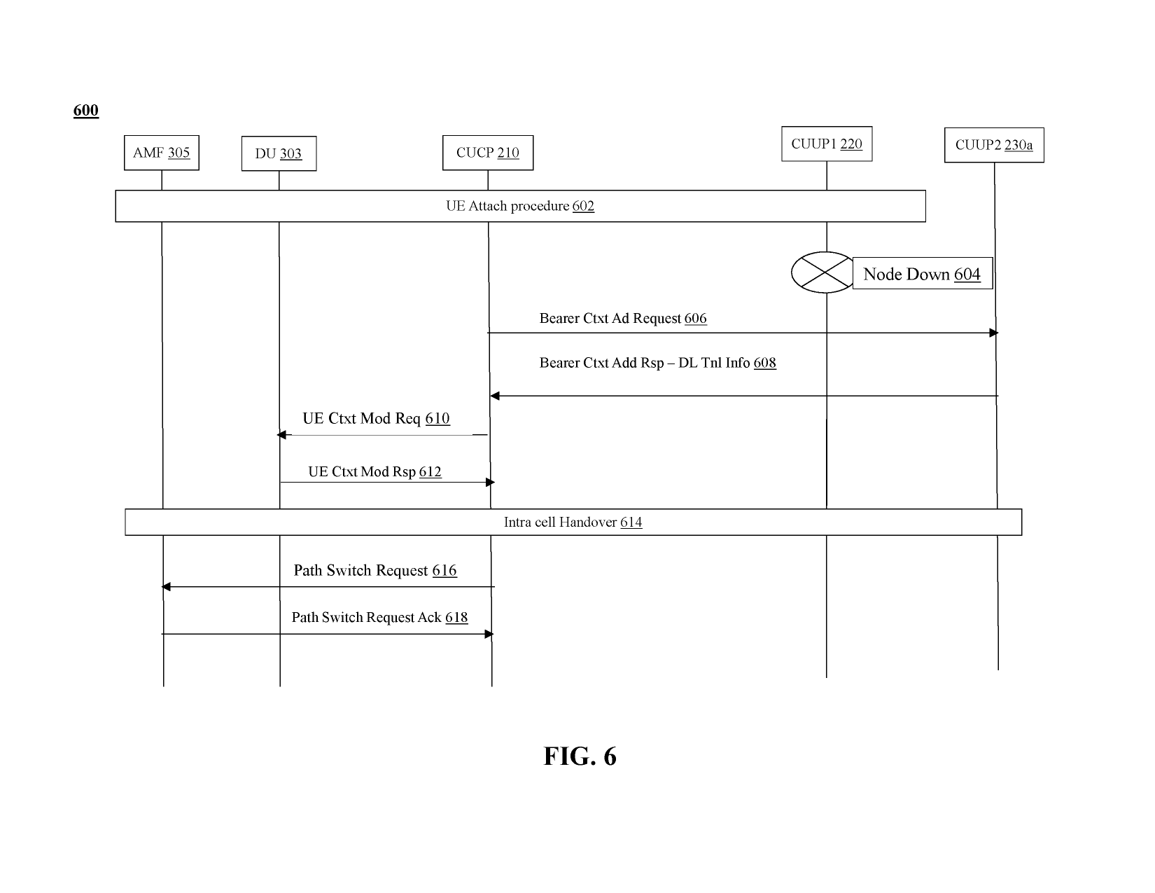

FIG. 6 illustrates a signal flow diagram 600 depicting switching of the user bearer context to the active CUUP 230a. As shown in FIG. 6, at operation 602, a UE is connected to the current CUUP (i.e., CUUP1) 220. At operation 604, the current CUUP 220 is down. At operation 606, the CUCP 210 transmits a Bearer Context addition request (i.e., Bearer Ctxt Ad Request) containing UL Tunnel endpoint information to the current CUUP 220. In response, at operation 608, a Bearer Context addition response (i.e. Bearer Ctxt Add Rsp) containing DL tunnel information is received. At operation 610, the UE context modification request (i.e., UE Ctxt Mod Req) is transmitted from the CUCP 210 to the DU 303. In response, at operation, UE Context Modification Response (i.e., UE Ctxt Mod Rsp) is received. At operation 614, the intra-cell handover is performed. It should be noted that the intra-cell handover process may be performed in accordance with any of the techniques as described in reference to FIGS. 3-5. Then, at operation 616, a path switch request is transmitted from the CUCP 210 to the AMF 305. In response, at operation 618, a path switch request acknowledgement (ack) is received.

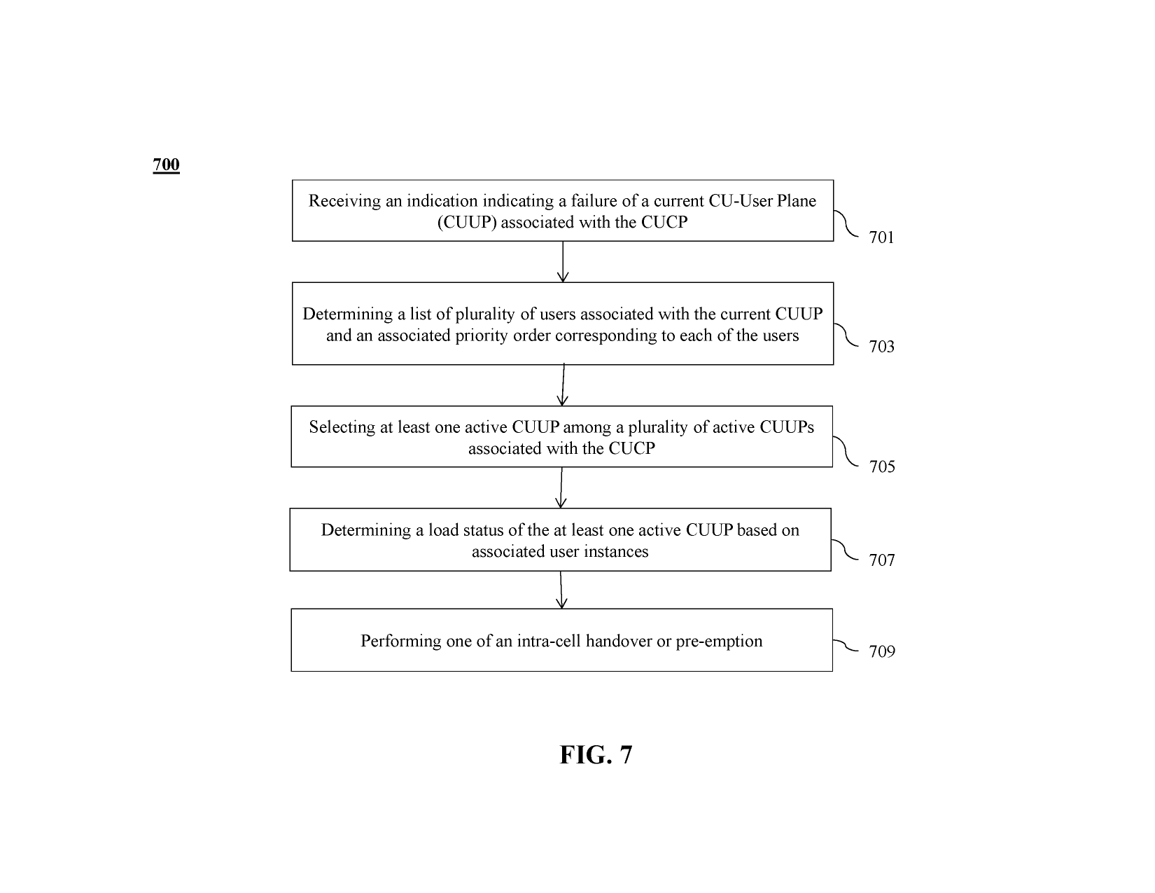

FIG. 7 illustrates a flowchart depicting a method 700 for switching the user bearer context to the active CUUP, according to an embodiment of the present disclosure. The method 700 may be performed by the apparatus 240.

At step 701, the method 700 may include receiving, by the CUCP 210, the indication indicating the failure of the current CUUP 220 associated with the CUCP 210.

At step 703, the method 700 may include determining, by the CUCP 210, a list of a plurality of users associated with the current CUUP 220 and an associated priority order corresponding to each of the users.

At step 705, the method 700 may include selecting, by the CUCP 210, the at least one active CUUP 230a among a plurality of active CUUPs 230 associated with the CUCP 210.

At step 707, the method 700 may include determining, by the CUCP 210, a load status of the at least one active CUUP 230a based on associated user instances.

At step 709, the method 700 may include performing, by the CUCP 210, one of: performing an intra-cell handover process to switch the user bearer context associated with each of the plurality of users from the current CUUP 220 to the at least one active CUUP 230a based on the corresponding priority order, when the load status is below a predefined threshold; or pre-empting one or more user instances corresponding to one or more non-priority users associated with the at least one active CUUP 230a when the load status is above the predefined threshold; and performing the intra-cell handover process to switch a first set of users among the plurality of users associated with the current CUUP 220 to the at least one active CUUP 230a based on the corresponding priority orders.

While the above-discussed steps in FIG. 7 are shown and described in a particular sequence, the steps may occur in variations to the sequence in accordance with various embodiments. Further, a detailed description related to the various steps of FIG. 7 is already covered in the description related to FIGS. 2-6 and is omitted herein for the sake of brevity.

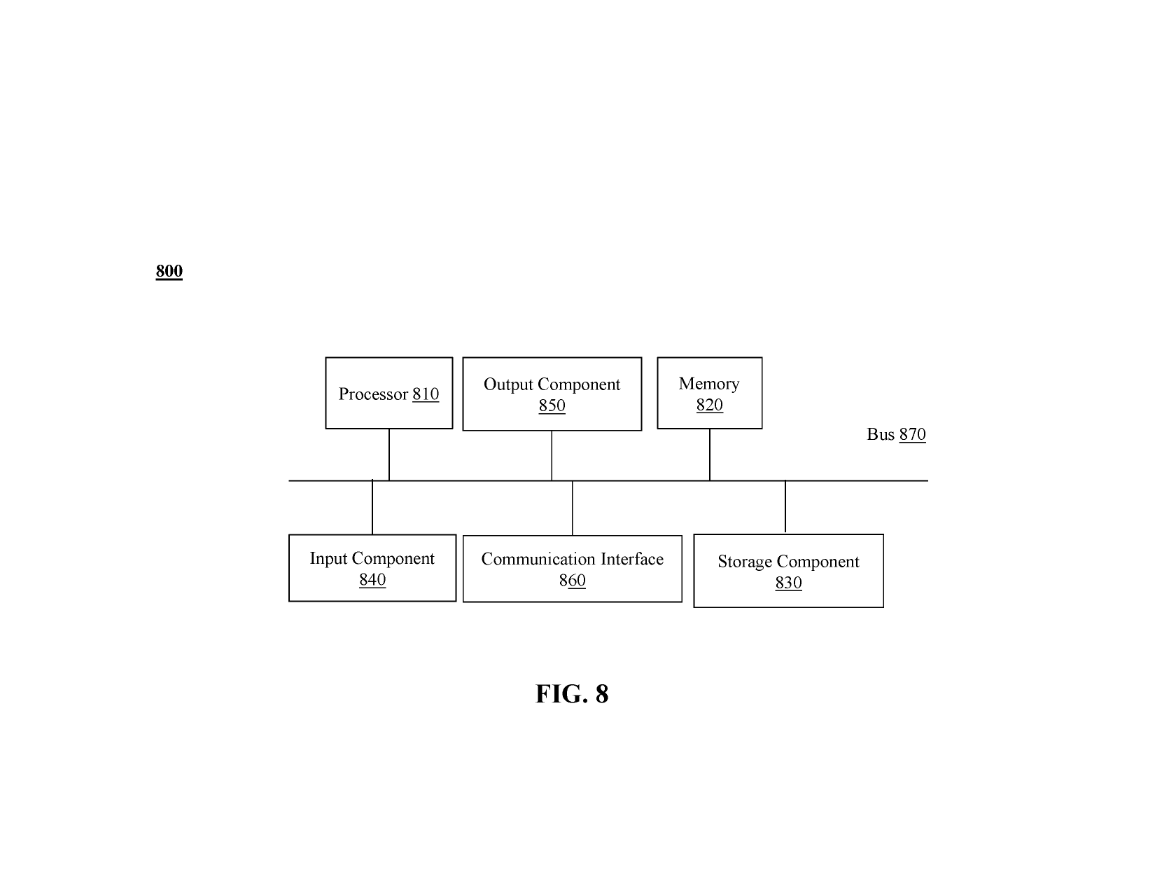

FIG. 8 is a diagram of example components of a wireless communication device 800 (also referred to as the device/apparatus 240), in accordance with an embodiment of the present disclosure. In one or more embodiments, the wireless communication device 800 may correspond to a wireless server and/or the apparatus 240. As shown in FIG. 8, the device 800 includes a processor 810, a memory 820, a storage component 830, an input component 840, an output component 850, a communication interface 860, and a bus 870.

The processor 810, as used herein, means any type of computational circuit that may comprise hardware elements and software elements. The processor 810 may be embodied as a multi-core processor, a single-core processor, or a combination of one or more multi-core processors and/or one or more single-core processors, a distributed processing system, or the like. The processor 810 may be a Central Processing Unit (CPU), a Graphics Processing Unit (GPU), an Accelerated Processing Unit (APU), an Application-Specific Integrated Circuit (ASIC), or another type of processing component.

The memory 820 includes a non-transitory computer-readable medium. The memory 820 includes a Random-Access Memory (RAM), a Read Only Memory (ROM), and/or another type of dynamic or static storage device (e.g., a flash memory, a magnetic memory, and/or an optical memory) that stores information and/or instructions for use by the processor 810. The memory 820 comprises machine-readable instructions which are executable by the processor 810. These machine-readable instructions when executed by the processor 810 cause the processor 810 to perform one or more method steps of an embodiment described above.

The storage component 830 stores information and/or software related to the operation and use of the device 800. For example, the storage component 830 may include a hard disk (e.g., a magnetic disk, an optical disk, a magneto-optic disk, and/or a solid-state disk), a Compact Disc (CD), a Digital Versatile Disc (DVD), a floppy disk, a cartridge, a magnetic tape, and/or another type of non-transitory computer-readable medium, along with a corresponding drive.

The input component 840 is configured to receive information, such as user input. For example, the input component 840 may include, but not be limited to, a touch screen display, a keyboard, a keypad, a mouse, a button, a switch, and/or a microphone. Additionally, or alternatively, the input component 840 may include a sensor for sensing information (e.g., a Global Positioning System (GPS), an accelerometer, a gyroscope, and/or an actuator).

The output component 850 is configured to provide output information from the device 800. For example, the output component 850 maybe, but is not limited to, a display, a speaker, an instruction device to an external device, and/or one or more Light-Emitting Diodes (LEDs).

The communication interface 860 is an interface that provides a communication connection to other devices, such as external devices and internal devices. The connection by the communication interface 860 can be a wired connection, a wireless connection, or a combination of wired and wireless connections, and can be a direct connection or an indirect connection via a communication network that exists between the device 800 and other devices. In other words, the standard of the communication interface 860 is not limited.

The bus 870 acts as an interconnect between the processor 810, the memory 820, the storage component 830, the input component 840, the output component 850, and the communication interface 860 of the device 800. The bus 870 may include a wired interconnection or a wireless interconnection.

The number and arrangement of components shown in FIG. 8 are provided as an example. In practice, the device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800. Further, one or more method steps described in any of the embodiments may be performed utilizing a plurality of devices 800 in communication with one another.

In one embodiment, a method is described. The method includes the method may include determining, by the CUCP, a list of a plurality of users associated with the current CUUP and an associated priority order corresponding to each of the users. The method may include selecting, by the CUCP, at least one active CUUP among a plurality of active CUUPs associated with the CUCP. In addition, the method may include determining, by the CUCP, a load status of the at least one active CUUP based on associated user instances. The method may include performing, by the CUCP, one of: performing an intra-cell handover process to switch a user bearer context associated with each of the plurality of users from the current CUUP to the at least one active CUUP based on the corresponding priority order, when the load status is below a predefined threshold; or pre-empting one or more user instances corresponding to one or more non-priority users associated with the at least one active CUUP when the load status is above the predefined threshold; and performing the intra-cell handover process to switch a first set of users among the plurality of users associated with the current CUUP to the at least one active CUUP based on the corresponding priority orders.

The method as described in , wherein pre-empting the one or more user instances comprises: pre-empting one or more user bearer contexts associated with the one or more non-priority users, when the one or more bearer contexts are associated with at least two active CUUPs among the plurality of active CUUPs.

The method as described in any one of -, wherein the first set of users comprises one or more of emergency users, high priority users, Radio Access Technology (RAT) Frequency Selection Priority Identifier (RFSPID)-based users, and Voice Over New Radio (VoNR) users.

The method as described in any one of -, wherein pre-empting the one or more user instances comprises: pre-empting, by the CUCP, the one or more user instances when a plurality of bearer contexts associated with each of the one or more user instances are associated with the at least one active CUUP.

The method as described in any one of -, wherein after performing the intra-cell handover process to switch the first set of users among the plurality of users associated with the current CUUP to the at least one active CUUP, the method comprises: releasing, by the CUCP, a second set of users among the plurality of users associated with the current CUUP, wherein the second set of users comprises one or more of inactive users, N-Carrier aggregation users, dual connectivity users, and cell edge users.

The method as described in any one of -, wherein performing the intra-cell handover process comprises: transmitting, by the CUCP, a bearer context setup request to the at least one active CUUP; and receiving, by the CUCP, a bearer context setup response from the at least one active CUUP.

The method as described in any one of -, further comprising: transmitting, by the CUCP, a User Equipment (UE) context setup request including an uplink (UL) tunnel information associated with the at least one active CUUP to a Distribution Unit (DU); receiving, by the CUCP, a UE context setup response including a downlink (DL) tunnel information associated with the at least one active CUUP from the DU; and receiving, by the CUUP, an UL Radio Resource Control (RRC) message from the DU.

The method as described in any one of -, wherein pre-empting the one or more user instances comprises: transmitting, by the CUCP, a bearer context release command to the at least one active CUUP, wherein the request includes an identification of the user bearer context to be pre-empted; and receiving, by the CUCP, a bearer context release complete from the at least one active CUUP.

The method as described in any one of -, further comprising: transmitting, by the CUCP, a UE context modification request including a list of one of the one or more user instances and the one or more user bearer context to a Distribution Unit (DU); receiving, by the CUCP, a UE context modification response from the DU; and receiving, by the CUCP, an UL Radio Resource Control (RRC) message from the DU.

In another embodiment, an apparatus is described. The apparatus is configured to receive an indication indicating a failure of a current CU-User Plane (CUUP) associated with the apparatus. In addition, the apparatus is configured to determine a list of a plurality of users associated with the current CUUP and an associated priority order corresponding to each of the users. Further, the apparatus is configured to select at least one active CUUP among a plurality of active CUUPs associated with the apparatus. Furthermore, the apparatus is configured to determine a load status of the at least one active CUUP based on associated user instances. Further, the apparatus is configured to perform one of: perform an intra-cell handover process to switch a user bearer context associated with each of the plurality of users from the current CUUP to the at least one active CUUP based on the corresponding priority order, when the load status is below a predefined threshold; or pre-empt corresponding to one or more non-priority users associated with the at least one active CUUP, when the load status is above the predefined threshold; and perform the intra-cell handover process to switch a first set of users among the plurality of users associated with the current CUUP to the at least one active CUUP based on the corresponding priority orders.

The apparatus as described in , wherein to pre-empt the one or more user instances, the apparatus is configured to: pre-empt one or more user bearer contexts associated with the one or more non-priority users, when the one or more bearer contexts are associated with at least two active CUUPs among the plurality of active CUUPs.

The apparatus as described in any one of -, wherein the first set of users comprises one or more of emergency users, high priority users, Radio Access Technology (RAT) Frequency Selection Priority Identifier (RFSPID)-based users, and Voice Over New Radio (VoNR) users.

The apparatus as described in any one of -, wherein to pre-empt the one or more user instances, the apparatus is configured to: pre-empt the one or more user instances when a plurality of bearer contexts associated with each of the one or more user instances are associated with the at least one active CUUP.

The apparatus as described in any one of -, wherein after performing the intra-cell handover process to switch the first set of users among the plurality of users associated with the current CUUP to the at least one active CUUP, the apparatus is configured to: release a second set of users among the plurality of users associated with the current CUUP, wherein the second set of users comprises one or more of inactive users, N-Carrier aggregation users, dual connectivity users, and cell edge users.

The apparatus as described in any one of -, wherein to perform the intra-cell handover process, the apparatus is configured to: transmit a bearer context setup request to the at least one active CUUP; and receive a bearer context setup response from the at least one active CUUP.

The apparatus as described in any one of -, wherein the apparatus is further configured to: transmit a User Equipment (UE) context setup request including an uplink (UL) tunnel information associated with the at least one active CUUP to a Distribution Unit (DU); receive a UE context setup response including a downlink (DL) tunnel information associated with the at least one active CUUP from the DU; and receive an UL Radio Resource Control (RRC) message from the DU.

The apparatus as described in any one of -, wherein to pre-empt the one or more user instances, the apparatus is configured to: transmit a bearer context release command to the at least one active CUUP, wherein the request includes an identification of the user instance to be pre-empted; and receive a bearer context release complete from the at least one active CUUP.

The apparatus as described in any one of -, wherein the apparatus is further configured to: transmit a UE context modification request including a list of one of the one or more user instances and the one or more user bearer context to a Distribution Unit (DU); receive a UE context modification response from the DU; and receive an UL Radio Resource Control (RRC) message from the DU.

The apparatus as described in any one of -, wherein the apparatus corresponds to a Centralized Unit Control Plane (CUCP).

In one embodiment, a non-transitory computer-readable medium storing instructions is described. The instructions comprising one or more instructions that, when executed by a Centralized Unit Control Plane (CUCP), the CUCP comprising one or more processors, cause the one or more processors to: receive an indication indicating a failure of a current CU-User Plane (CUUP) associated with the apparatus; determine a list of plurality of users associated with the current CUUP and an associated priority order corresponding to each of the users; select at least one active CUUP among a plurality of active CUUPs associated with the apparatus; determine a load status of the at least one active CUUP based on associated user instances; and perform one of: perform an intra-cell handover process to switch a user bearer context associated with each of the plurality of users from the current CUUP to the at least one active CUUP based on the corresponding priority order, when the load status is below a predefined threshold; or pre-empt corresponding to one or more non-priority users associated with the at least one active CUUP, when the load status is above the predefined threshold; and perform the intra-cell handover process to switch a first set of users among the plurality of users associated with the current CUUP to the at least one active CUUP based on the corresponding priority orders.

It is understood that terms including “unit” or “module” at the end may refer to the unit for processing at least one function or operation and may be implemented in hardware, software, or a combination of hardware and software.

Accordingly, the present disclosure provides techniques for switching the user bearer context to the active CUUP.

Embodiments of the present disclosure offer several significant commercial and technical advantages, for example:

Reducing Call Drops: Switching the users associated with a failed CUUP to an active CUUP results in reduced call drops.

Better service to High-Priority Users: High-Priority users such as emergency users are switched even if the active CUUP is overloaded by pre-empting the users of the active CUUP. This leads to providing better service to the high-priority users.

Enhancing User Experience: The users associated with a failed CUUP are switched to an active CUUP, resulting in reduced call drops, thereby enhancing the user experience.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method comprising:
receiving, by a Centralized Unit Control Plane (CUCP), an indication indicating a failure of a current CU-User Plane (CUUP) associated with the CUCP;
determining, by the CUCP, a list of a plurality of users associated with the current CUUP and an associated priority order corresponding to each of the users;
selecting, by the CUCP, at least one active CUUP among a plurality of active CUUPs associated with the CUCP;
determining, by the CUCP, a load status of the at least one active CUUP based on associated user instances;
performing, by the CUCP, one of:
performing an intra-cell handover process to switch a user bearer context associated with each of the plurality of users from the current CUUP to the at least one active CUUP based on the corresponding priority order, when the load status is below a predefined threshold; or
pre-empting one or more user instances corresponding to one or more non-priority users associated with the at least one active CUUP when the load status is above the predefined threshold; and
performing the intra-cell handover process to switch a first set of users among the plurality of users associated with the current CUUP to the at least one active CUUP based on the corresponding priority orders.

2. The method as claimed in claim 1, wherein pre-empting the one or more user instances comprises:
pre-empting one or more user bearer contexts associated with the one or more non-priority users, when the one or more bearer contexts are associated with at least two active CUUPs among the plurality of active CUUPs.

3. The method as claimed in claim 1, wherein the first set of users comprises one or more of emergency users, high priority users, Radio Access Technology (RAT) Frequency Selection Priority Identifier (RFSPID)-based users, and Voice Over New Radio (VoNR) users.

4. The method as claimed in claim 1, wherein pre-empting the one or more user instances comprises:
pre-empting, by the CUCP, the one or more user instances when a plurality of bearer contexts associated with each of the one or more user instances are associated with the at least one active CUUP.

5. The method as claimed in claim 1, wherein after performing the intra-cell handover process to switch the first set of users among the plurality of users associated with the current CUUP to the at least one active CUUP, the method (800) comprises:
releasing, by the CUCP, a second set of users among the plurality of users associated with the current CUUP, wherein the second set of users comprises one or more of inactive users, N-Carrier aggregation users, dual connectivity users, and cell edge users .

6. The method as claimed in claim 1, wherein performing the intra-cell handover process comprises:
transmitting, by the CUCP, a bearer context setup request to the at least one active CUUP; and
receiving, by the CUCP, a bearer context setup response from the at least one active CUUP.

7. The method as claimed in claim 6, further comprising:
transmitting, by the CUCP, a User Equipment (UE) context setup request including an uplink (UL) tunnel information associated with the at least one active CUUP to a Distribution Unit (DU);
receiving, by the CUCP, a UE context setup response including a downlink (DL) tunnel information associated with the at least one active CUUP from the DU;
receiving, by the CUUP, an UL Radio Resource Control (RRC) message from the DU;
transmitting, by the CUCP, a path switch request with DL tunnel information to an Access and Mobility Management Function (AMF); and
receiving, by the CUCP, a path request acknowledgment from the AMF to switch data associated with the UE context to the at least one active CUUP.

8. The method as claimed in claim 1, wherein pre-empting the one or more user instances comprises:
transmitting, by the CUCP, a bearer context release command to the at least one active CUUP, wherein the request includes an identification of the user bearer context to be pre-empted; and
receiving, by the CUCP, a bearer context release complete from the at least one active CUUP.

9. The method as claimed in claim 8, further comprising:
transmitting, by the CUCP, a UE context modification request including a list of one of the one or more user instances and the one or more user bearer context to a Distribution Unit (DU);
receiving, by the CUCP, a UE context modification response from the DU; and
receiving, by the CUCP, an UL Radio Resource Control (RRC) message from the DU.

10. An apparatus configured to:
receive an indication indicating a failure of a current Centralized Unit (CU)-User Plane (CUUP) associated with the apparatus;
determine a list of a plurality of users associated with the current CUUP and an associated priority order corresponding to each of the users;
select at least one active CUUP among a plurality of active CUUPs associated with the apparatus;
determine a load status of the at least one active CUUP based on associated user instances;
perform one of:
perform an intra-cell handover process to switch a user bearer context associated with each of the plurality of users from the current CUUP to the at least one active CUUP based on the corresponding priority order, when the load status is below a predefined threshold; or
pre-empt one or more user instances corresponding to one or more non-priority users associated with the at least one active CUUP, when the load status is above the predefined threshold; and
perform the intra-cell handover process to switch a first set of users among the plurality of users associated with the current CUUP to the at least one active CUUP based on the corresponding priority orders.

11. The apparatus as claimed in claim 10, wherein to pre-empt the one or more user instances, the apparatus is configured to:
pre-empt one or more user bearer contexts associated with the one or more non-priority users, when the one or more bearer contexts are associated with at least two active CUUPs among the plurality of active CUUPs.

12. The apparatus as claimed in claim 10, wherein the first set of users comprises one or more of emergency users, high priority users, RFSPID-based users, and Voice Over New Radio (VoNR) users.

13. The apparatus as claimed in claim 10, wherein to pre-empt the one or more user instances, the apparatus is configured to:
pre-empt the one or more user instances when a plurality of bearer contexts associated with each of the one or more user instances are associated with the at least one active CUUP.

14. The apparatus as claimed in claim 10, wherein after performing the intra-cell handover process to switch the first set of users among the plurality of users associated with the current CUUP to the at least one active CUUP, the apparatus is configured to:
release a second set of users among the plurality of users associated with the current CUUP, wherein the second set of users comprises one or more of inactive users, N-Carrier aggregation users, dual connectivity users, and cell edge users.

15. The apparatus as claimed in claim 10, wherein to perform the intra-cell handover process, the apparatus is configured to:
transmit a bearer context setup request to the at least one active CUUP; and
receive a bearer context setup response from the at least one active CUUP.

16. The apparatus as claimed in claim 15, wherein the apparatus is further configured to:
transmit a User Equipment (UE) context setup request including an uplink (UL) tunnel information associated with the at least one active CUUP to a distribution unit (DU);
receive a UE context setup response including a Downlink (DL) tunnel information associated with the at least one active CUUP from the DU;
receive an UL Radio Resource Control (RRC) message from the DU;
transmit a path switch request with DL tunnel information to an Access and Mobility Management Function (AMF); and
receive a path request acknowledgment from the AMF to switch data associated with the UE context to the at least one active CUUP.

17. The apparatus as claimed in claim 10, wherein to pre-empt the one or more user instances, the apparatus is configured to:
transmit a bearer context release command to the at least one active CUUP, wherein the request includes an identification of the user bearer context to be pre-empted; and
receive a bearer context release complete from the at least one active CUUP.

18. The apparatus as claimed in claim 17, wherein the apparatus is further configured to:
transmit a UE context modification request including a list of one of the one or more user instances and the one or more user bearer context to a distribution unit (DU);
receive a UE context modification response from the DU; and
receive an UL Radio Resource Control (RRC) message from the DU.

19. The apparatus as claimed in claim 10, wherein the apparatus corresponds to a Centralized Unit Control Plane (CUCP).

20. A non-transitory computer-readable medium storing instructions, the instructions comprising: one or more instructions that, when executed by a Centralized Unit Control Plane (CUCP), the CUCP comprising one or more processors, cause the one or more processors to:
receive an indication indicating a failure of a current CU-User Plane (CUUP) associated with the CUCP;
determine a list of plurality of users associated with the current CUUP and an associated priority order corresponding to each of the users;
select at least one active CUUP among a plurality of active CUUPs associated with the CUCP;
determine a load status of the at least one active CUUP based on associated user instances;
perform one of:
perform an intra-cell handover process to switch a user bearer context associated with each of the plurality of users from the current CUUP to the at least one active CUUP based on the corresponding priority order, when the load status is below a predefined threshold; or
pre-empt one or more user instances corresponding to one or more non-priority users associated with the at least one active CUUP, when the load status is above the predefined threshold; and
perform the intra-cell handover process to switch a first set of users among the plurality of users associated with the current CUUP to the at least one active CUUP based on the corresponding priority orders.
